(19) United States
(12) Patent Application Publication
(10) Pub. No.: US 2010/0073146 A1
(43) Pub. Date: Mar. 25, 2010

(54) Method Of Controlling Communication Frequencies Of Wireless Communication System, Controller Of The System, And Wireless Communication System

(75) Inventors: Manabu KAI, Kawasaki (JP); Toru MANIWA, Kawasaki (JP); Kazunori YAMANAKA, Kawasaki-shi, Kanagawa (JP); Akihiko AKASEGAWA, Kawasaki (JP); Teru NAKANISHI, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki-shi (JP)

(21) Appl. No.: 12/626,098

(22) Filed: Nov. 25, 2009

Related U.S. Application Data
(63) Continuation of application No. PCT/JP2007/061050, filed on May 31, 2007.

(51) Int. Cl. G08C 19/00; H04B 15/00

(52) U.S. Cl. 340/10.5; 455/63.1; 340/825.72

(57) ABSTRACT

The wireless communication system sets at least one of the multiple wireless frequencies as a reception frequency from the wireless tag, and controls the temperature of a superconducting filter in response to the selected reception frequency, thereby the pass band or the rejection band of the superconducting filter is controlled.

### CROSS-REFERENCE TO RELATED APPLICATION

This application is a continuation Application of a PCT international application No. PCT/JP2007/61050 filed on May 31, 2007 in Japan, the entire contents of which are incorporated by reference.

### FIELD

The embodiments discussed herein are related to a method of controlling communication frequencies of a wireless communication system, a controller of the system, and the wireless communication system.

### BACKGROUND

RFID (Radio Frequency IDentification) is a technology that involves transmission of wireless signals between wireless tags attached to articles and the like and reader/writer systems for reading/writing of the information stored in the wireless tags.

The wireless tags include active tags that have their own power source (for example, battery cells) therein, and passive tags that are powered by wireless waves from reader/writer antennas of reader/writer systems. A case where the wireless tags are passive tags will be explained below, but similar explanation can be applied to a case of active tags.

In RFID, a reader/writer antenna transmits wireless signals including a control signal to a wireless tag in which ID (IDentification) information is embedded. Upon having received the wireless signals, the wireless tag drives the circuit contained therein to perform various processings based on the received signals, using a power source contained in the wireless signals, for example. The wireless tag reflects a part of the wireless signals from the reader/writer antenna, such that predetermined information (such as the ID information and the results of the processings) is transmitted to the reader/writer antenna together with the reflected waves.

The communication distance between the wireless tag and the reader/writer antenna is, for example, about 3 m to 5 m. In Japan, for example, the range of 952 MHz to 954 MHz is used as a wireless (frequency) bandwidth for RFID.

The wireless bandwidth ranging from 952 MHz to 954 MHz is divided into multiple wireless channels (wireless frequencies) at 0.2-MHz intervals, which are assigned to wireless channels 1 to 9 (channel 1=952.2 MHz, channel 2=952.4 MHz, . . . , and channel 9=953.8 MHz), respectively.

Hence, even when multiple reader/writer systems are installed, appropriate assignment of the wireless channels to respective systems can suppress interference between the reader/writer systems.

The following Patent Document 1 discloses a technique for preventing interference between wireless signals using a device having a superconducting filter.

Patent Document 1: WO 2002/067446

Unfortunately, under a circumstance that multiple reader/writer systems are installed very closely to one another, the above assignment of the wireless channels for the respective reader/writer systems may not completely prevent interference. In that case, such interference eventually reduces the communication distance between a reader/writer antenna and a wireless tag, or impairs the read rate of the wireless tag.

Thus, for example, a bandpass filter may be applied to each wireless channel to eliminate frequency components (interference components) other than the frequency components of the wireless channel required for each reader/writer system. However, as described above, since the wireless channels used in RFID are spaced only at 0.2 MHz intervals, use of an ordinary bandpass filter does not yield transmission of the signal of the required wireless channel.

For example, FIG. 9 illustrates transmission and reflection characteristics of a bandpass filter made of copper (Cu) for a very narrow bandwidth of 0.2 MHz (hereinafter referred to as Cu filter). In FIG. 9, the symbol “a” indicates the transmission characteristics of the Cu filter, whereas the symbol “b” indicates the reflection characteristics of the Cu filter, where the electrical conductivity of Cu is 5×10⁷ (S/m).

As can be seen from the transmission and reflection characteristics indicated by the symbols a and b, the Cu filter has a transmission loss of about −70 dB and a reflection loss of about 0 dB for the wireless bandwidth of 952 MHz to 954 MHz. This indicates that most of the input signals are reflected by the Cu filter, and that the required filter characteristics are not realized within the wireless bandwidth.

The use of an ordinary Cu filter for each wireless channel in RFID, the filter being designed for a very narrow bandwidth of 0.2 MHz, results in significantly large loss at the pass band, which cannot transmit the input signals.

In addition, the use of such Cu filters to these wireless channels requires circuits for switching filters, increasing the size of the reader/writer system.

Patent Document 1 includes no disclosure or suggestion for the problems and their solutions.

### SUMMARY

(1) According to an aspect of the embodiment, a method includes a method of controlling communication frequencies of a wireless communication system including a wireless tag, a superconducting filter that passes or blocks at least one of the signals of multiple wireless frequencies that are used for communication with the wireless tag, and a controller for controlling the temperature of the superconducting filter, the method including: on the controller, selecting at least one of the plurality of wireless frequencies as a reception frequency from the wireless tags; and controlling the temperature of the superconducting filter in response to the selected reception frequency, so as to control the pass band or rejection band of the superconducting filter.

(2) According to an aspect of the embodiment, an apparatus includes a controller of the wireless communication system including: a wireless tag; and a superconducting filter that passes or blocks at least one of the signals of multiple wireless frequencies that are used for communication with the wireless tags, and the controller further includes: reception frequency setting unit that sets at least one of the plurality of wireless frequencies as a reception frequency from the wireless tag; and temperature controlling unit that controls the temperature of the superconducting filter in response to the reception frequency set by the reception frequency setting unit, so as to control the pass band or rejection band of the superconducting filter.

(3) According to an aspect of the embodiment, a system includes a wireless communication system performing communication using a wireless tag and at least one of multiple wireless frequencies, including: a superconducting filter that passes or blocks at least one of the signals of the multiple wireless frequencies; and a controller comprising reception frequency setting unit that sets at least one of the multiple wireless frequencies as a reception frequency from the wireless tag, and temperature controlling unit that controls the temperature of the superconducting filter in response to the reception frequency selected by the reception frequency setting unit, whereby the pass band or rejection band of the superconducting filter is controlled.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating a configuration of a reader/writer system according to an embodiment.

FIG. 2 is a diagram illustrating a structure of a superconducting filter used in the reader/writer system illustrated in FIG. 1.

FIG. 3 is a graph illustrating the dependence of center frequency on temperature of the superconducting filter illustrated in FIG. 2.

FIG. 4 is a magnified graph around T=70(K) of the characteristic curve illustrated in FIG. 3.

FIG. 5 is a graph illustrating characteristic curves of transmission and reflection at T=70(K) of the superconducting filter illustrated in FIG. 2.

FIG. 6 is a flow chart illustrating a filter control operation of the reader/writer system illustrated in FIG. 1.

FIG. 7 is a diagram illustrating a variation of the superconducting filter illustrated in FIG. 2.

FIG. 8 is a graph illustrating the transmission characteristics of the superconducting filter illustrated in FIG. 7.

FIG. 9 is a graph illustrating characteristic curves of transmission and reflection of a Cu filter.

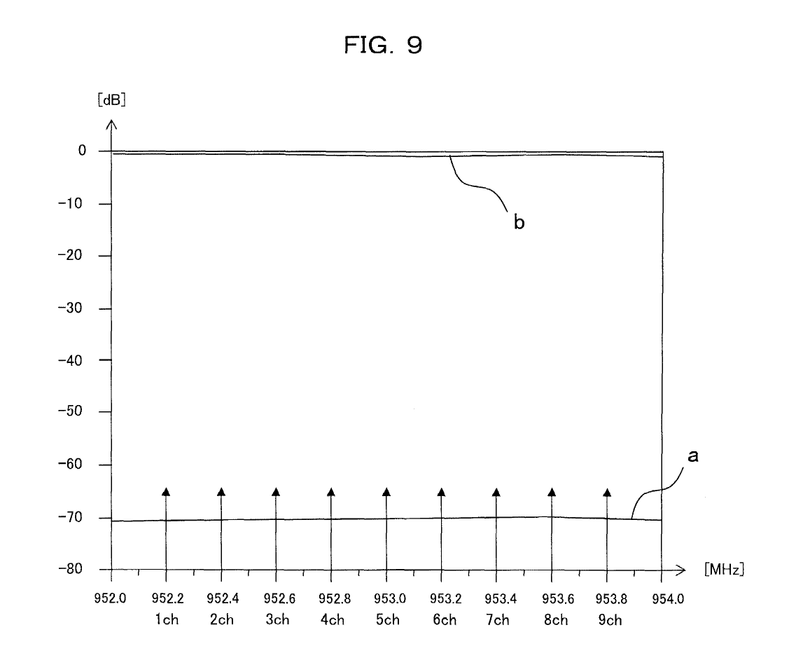

### DESCRIPTION OF EMBODIMENTS

### [A] Explanation of Embodiments

(Configuration of Reader/Writer System)

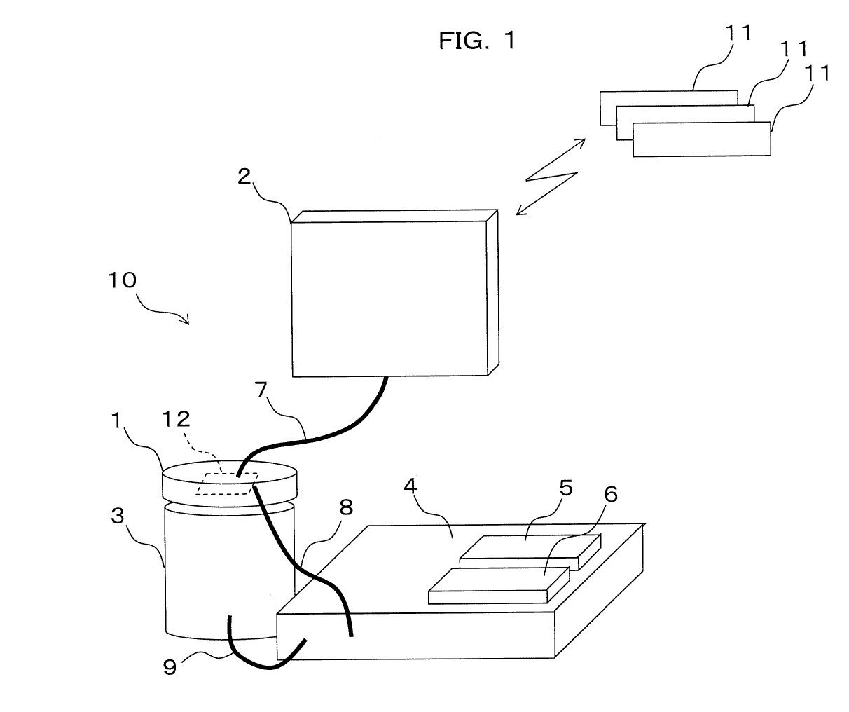

FIG. 1 is a diagram illustrating a configuration of the main part of a reader/writer system according to an embodiment. A reader/writer system 10 illustrated in FIG. 1 includes a reader/writer antenna 2, RF cables 7 and 8, a filter package 1, a superconducting filter 12, a freezer 3, a cable 9, a reader/writer unit 4, a ch-T (wireless channel information and temperature information) database 5, and a temperature controller 6. The reader/writer system 10 can read/write data from/to wireless tags 11 using wireless signals, for example.

The reader/writer antenna 2 transmits/receives wireless signals to/from the wireless tags 11. For example, the antenna 2 transmits wireless signals including control signals to the wireless tags 11 containing ID information, while receiving a part of the signals reflected by the wireless tags 11. The reader/writer antenna 2 is connected to the superconducting filter 12 housed in the filter package 1, by the RF cable 7.

The filter package 1, for example, is composed of a vacuum vessel made of a heat-insulating material, and the superconducting filter 12 is installed therein, so that thermal conduction from the outside to the superconducting filter 12 can be prevented.

The superconducting filter 12 filters the wireless signals received by the reader/writer antenna 2, and can transmit signals of one wireless channel among multiple wireless channels within a wireless band (for example, 952 MHz to 954 MHz) used in RFID. In other words, since the center frequency f₀ of the pass band of the superconducting filter 12 can be shifted in response to a change in temperature, the superconducting filter 12 is thermally controlled depending on a required wireless channel to be received, so as to transmit the reception signals of the required wireless channel.

Therefore, the superconducting filter 12 (filter package 1) is placed in contact with the freezer 3 (cold head), and the freezer 3 is connected to the reader/writer unit 4 by the cable 9, thereby the temperature controller 6 can control the temperature of the freezer 3. The superconducting filter 12 is connected to the reader/writer unit 4 by the RF cable 8, which can transmits wireless sending/reception signals. The overall size (volume) of the filter package 1 and the freezer 3 is almost equal to that of the reader/writer antenna 2 when the freezer 3 used is compact.

The reader/writer unit (controller) 4 performs various controls (setting wireless channels, controlling the temperature of the freezer 3, generating control signals to the wireless tags 11, and the like) for the reader/writer system 10.

The ch-T database 5 is a database (such as a memory) containing information on the wireless channels and respective temperatures of the superconducting filter 12. The temperature controller 6 controls the temperature of the freezer 3 based on the control from the reader/writer unit 4.

The reader/writer unit 4, for example, has a wireless channel selection (carrier sense) control function for selecting (setting) a wireless channel other than the wireless channels selected by other adjacent reader/writer systems, as a wireless channel (reception frequency) to be received by the reader/writer antenna 2, and a function for controlling the temperature of the superconducting filter 12 by controlling the temperature of the freezer 3 in cooperation with the ch-T database 5 and the temperature controller 6 such that the signals of the wireless channel selected by the reader/writer unit 4 pass through the superconducting filter 12.

Specifically, the reader/writer unit 4 has a function as reception frequency setting means for selecting (setting) a wireless channel (reception frequency) to be used in the wireless communication with the wireless tags 11, and the temperature controller 6 controls the temperature of the superconducting filter 12 by extracting (retrieving) the temperature information corresponding to the wireless channel from the ch-T database 5, and controlling the temperature of the freezer 3 based on the temperature information, such that the signals of the selected (set) wireless channel pass through the superconducting filter 12.

The reader/writer unit 4 and the temperature controller 6 control the temperature of the freezer 3 based on the temperature information of the wireless channel for RFID from the ch-T database 5, so that the units function as a controller that shifts the center frequency f₀ of a pass band of the superconducting filter 12.

In the reader/writer system 10 according to an embodiment that is configured as described above, the reader/writer unit 4 performs carrier sensing, selects a wireless channel to be used in the communication with the wireless tags 11, and controls the temperature of the freezer 3 to control the center frequency f₀ of the superconducting filter 12, so as to transmit the signals of the wireless channel.

Hence, the reader/writer system 10 receives the desirable wireless channel selected by the reader/writer unit 4, while rejecting the receipt of the interfering wireless channels from the other reader/writer systems. Consequently, even when multiple reader/writer systems 10 are used close to one another, mutual interferences caused by these reader/writer systems 10 can be prevented, so as not to impair the communication performance between each reader/writer system 10 and the wireless tags 11.

Because the center frequency f₀ of a pass band of the superconducting filter 12 is shifted based on the temperature control of the superconducting filter 12, only one superconducting filter 12 is necessary to selectively transmit signals of one wireless channel among multiple wireless channels of RFID. Hence, the reader/writer system 10 can have a smaller size than that of a system having multiple filters corresponding to multiple wireless channels.

Further, the reader/writer unit 4 extracts the temperature information corresponding to the selected wireless channel from the ch-T database 5, and controls the center frequency f₀ of the pass band of the superconducting filter 12 based on the temperature information, which simplifies the temperature control process for the superconducting filter 12.

(Explanation of Superconducting Filter 12)

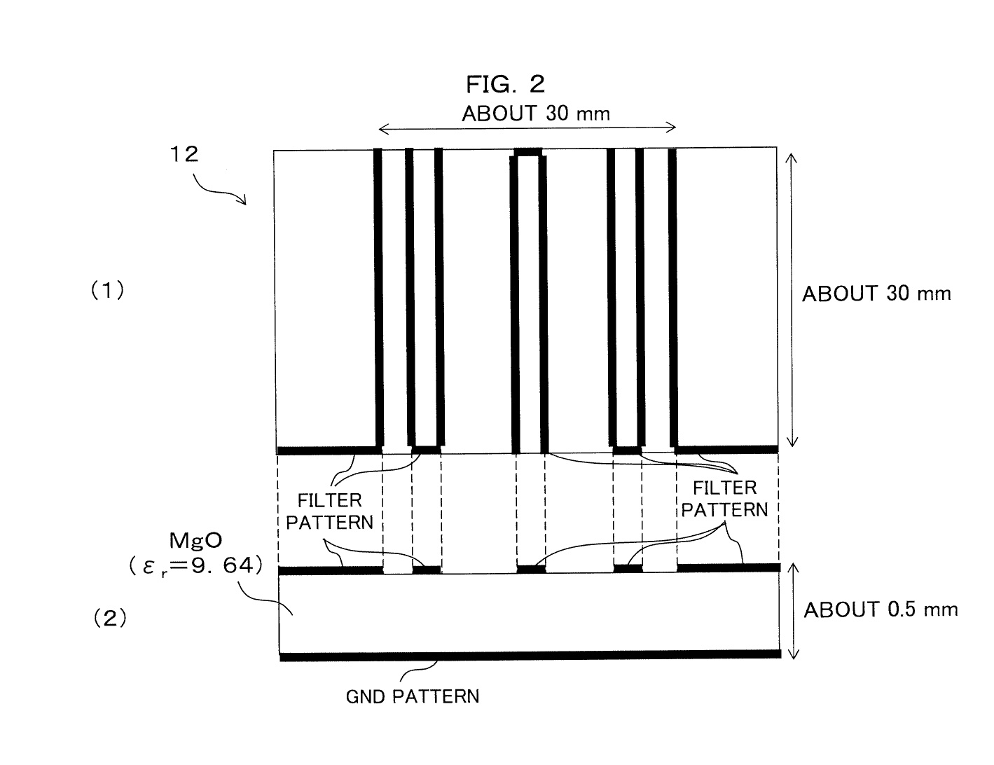

The superconducting filter 12 is explained with reference to FIG. 2. FIG. 2 is a diagram illustrating a structure of the superconducting filter 12 included in the reader/writer system 10: Part (1) illustrates a top view of the superconducting filter 12; and Part (2) illustrates a side view of the filter 12.

As illustrated in Part (2) of FIG. 2, the superconducting filter 12 of this embodiment is, for example, made of a magnesium oxide (MgO) substrate having a relative permittivity εᵣ=9.64 and a thickness d of 0.5 mm, the substrate having one surface on which a filter pattern composed of microstrip lines of yttrium-based oxide (YBCO) is formed, and the other surface on which a ground (GND) pattern is formed, where YBCO is a high-temperature superconductor having a critical temperature T_{c} of 90(K).

As illustrated in Part (1) of FIG. 2, the filter pattern has, for example, a hairpin resonator structure. In this embodiment, the pattern includes a three-stage filter to limit its size to about 30 mm by 30 mm. Accordingly, the filter package 1 having a diameter of about 10 cm has enough room to install the superconducting filter 12 therein. Although the superconducting filter 12 of this embodiment has three stages, the superconducting filter 12 may have any other structure. For example, more number of stages of the filters results in sharper cut-off characteristics of the superconducting filter 12, whereas less number of stages of the filters results in more moderate cut-off characteristics.

As described above, the superconducting filter 12 having a hairpin resonator structure simplifies the manufacture of the superconducting filter 12, which can reduce the manufacturing cost of the reader/writer system. The filter pattern may be of a helical shape.

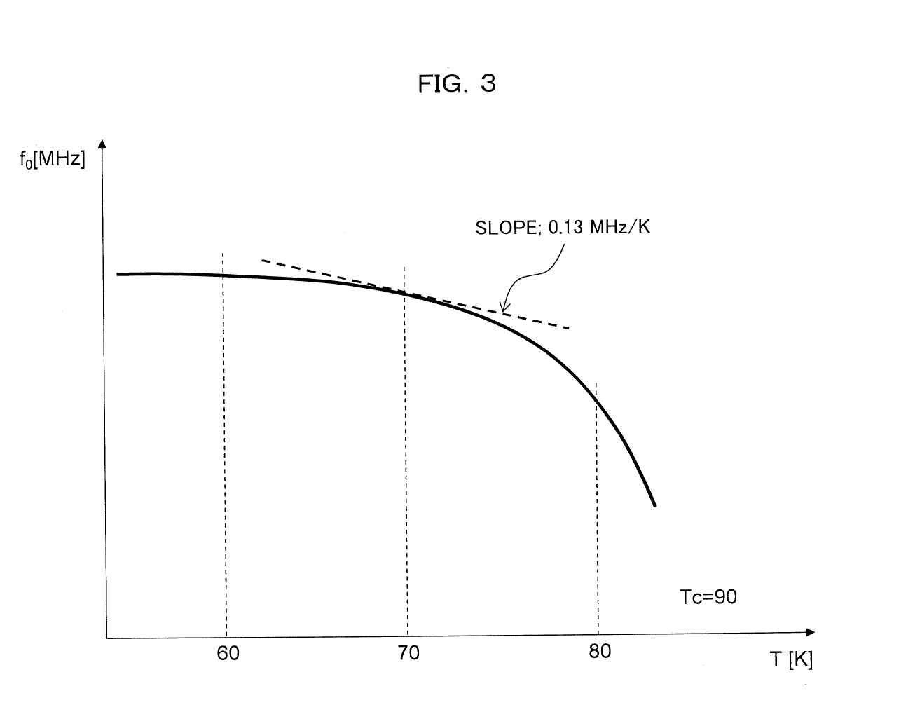

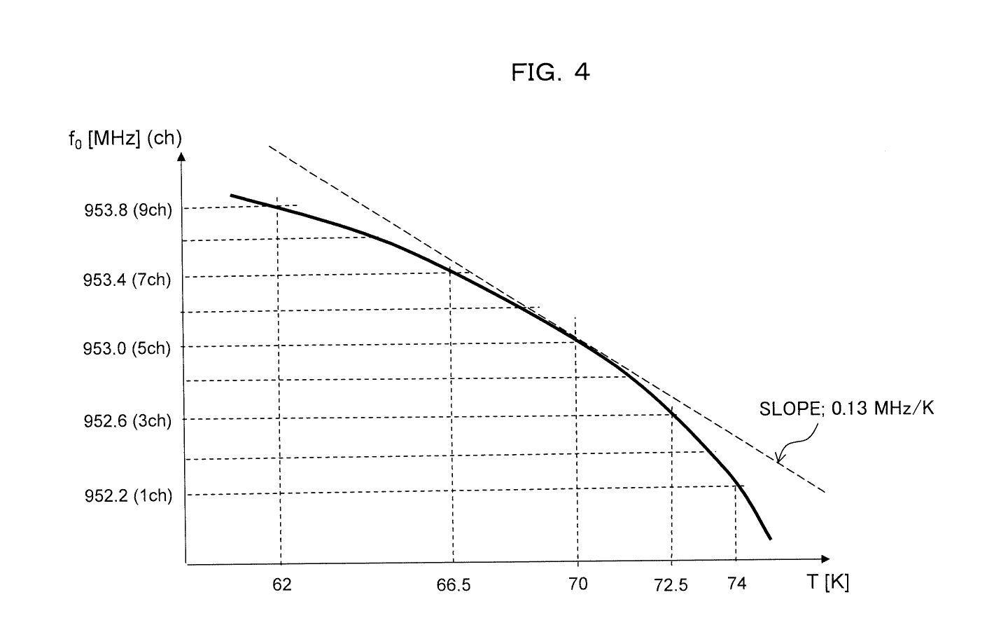

Now, the center frequency f₀ of the pass band of the superconducting filter 12 is explained with reference to FIGS. 3 and 4. FIG. 3 is a graph illustrating the dependence of the center frequency f₀ on temperature of the pass band of the superconducting filter 12. FIG. 4 is a magnified graph around T=70(K) of the graph illustrated in FIG. 3.

As illustrated in FIG. 4, the center frequency f₀ (MHz) of the superconducting filter 12 as a bandpass filter shifts in response to a change in temperature T (K). The center frequency f₀ here refers to the center value of a wireless frequency band that can pass through the superconducting filter 12.

YBCO, which exhibits a superconducting phase at a relatively high critical temperature Tc of 90 (k), is generally used at around 70 (K) where the superconducting phase is stable. At T=70 (K), the variation (the slope of the tangent line) is 0.13 (MHz/K).

As illustrated in FIG. 4, the characteristic curve of the filter observed around T=70 (K) can cover the wireless channels (channels 1 to 9; 952.2 (MHz) to 953.8 (MHz)) used in the reader/writer system 10.

For example, setting the temperature T of the superconducting filter 12 at 62 (K) settles the center frequency f₀ at 953.8 (MHz), whereas setting the temperature T at 66.5 (K) settles the center frequency f₀ at 953.4 (MHz).

For example, when the reader/writer unit 4 selects channel 7 (953.4 MHz) as a wireless channel used for communication with the wireless tags 11, the temperature T of the superconducting filter 12 is set (controlled) to 66.5 (K) to obtain filter (bandpass) characteristics that can transmit the wireless channel (channel 7).

Furthermore, in this embodiment, in order to simplify the temperature control process, the relationship between the center frequency f₀ and the temperature T around 70 (K) are preliminarily stored in the ch-T database 5. The reader/writer unit 4 extracts the temperature information corresponding to a selected wireless channel from the ch-T database 5, and causes the temperature controller 6, based on the temperature information, to control the temperature of the freezer 3 and the superconducting filter 12.

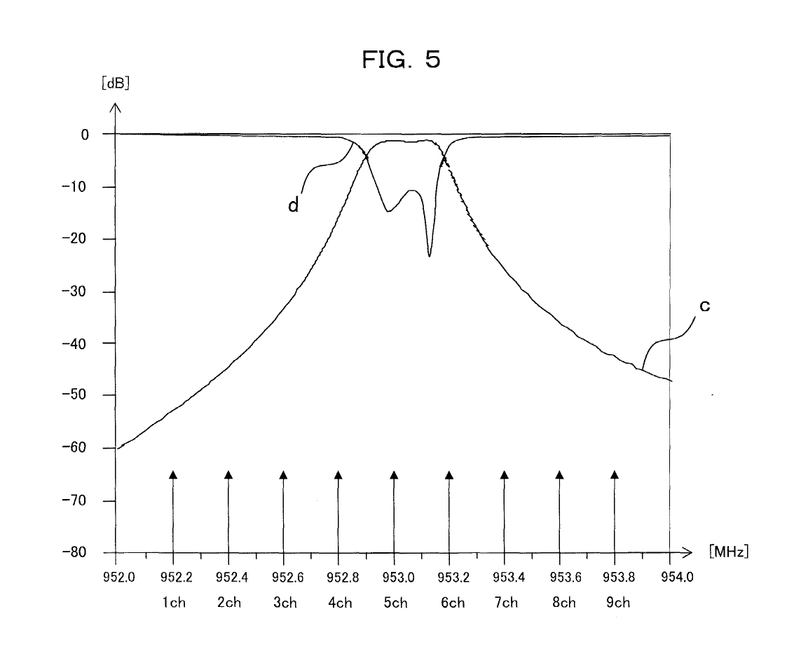

Next, the transmission and reflection characteristics of the superconducting filter 12 are explained with reference to FIG. 5. FIG. 5 is a graph illustrating the transmission and reflection characteristics at T=70(k) of the superconducting filter 12 having the structure of FIG. 2. In FIG. 5, the symbol “c” indicates a transmission characteristic curve of the superconducting filter 12, whereas the symbol “d” indicates a reflection characteristic curve, where the electric conductivity σ of the superconducting filter 12 is 7.63×10¹³ (S/m).

As can be seen from the transmission characteristic curve indicated by the symbol c, for the superconducting filter 12 at a temperature T=70 (K), the loss at a center frequency f₀=953 (MHz) (channel 5) is −1.18 (dB), which is quite small. To the contrary, a larger loss is observed at the other wireless bands.

As can be seen from the reflection characteristic curve indicated by the symbol d, almost no reflection waves are observed at wireless bands around the center frequency f₀=953 (MHz) (channel 5), but in the other wireless bands, most of the input waves to the superconducting filter 12 are reflected.

As described above, the superconducting filter 12 exhibits a significantly narrow (for example, about 0.2 MHz) bandpass region around the center frequency f₀.

For example, the loss at 953.2 (MHz) (channel 6) adjacent to 953 (MHz) (channel 5) is about 7 (dB), and the loss at 953.4 (MHz) (channel 7) is about 26 (dB), which indicates no interference occurs between the wireless signals of channel 5 and the wireless signals of channel 6 or 7 when channel 5 is selected as a wireless channel.

(Operation of Reader/Writer System 10)

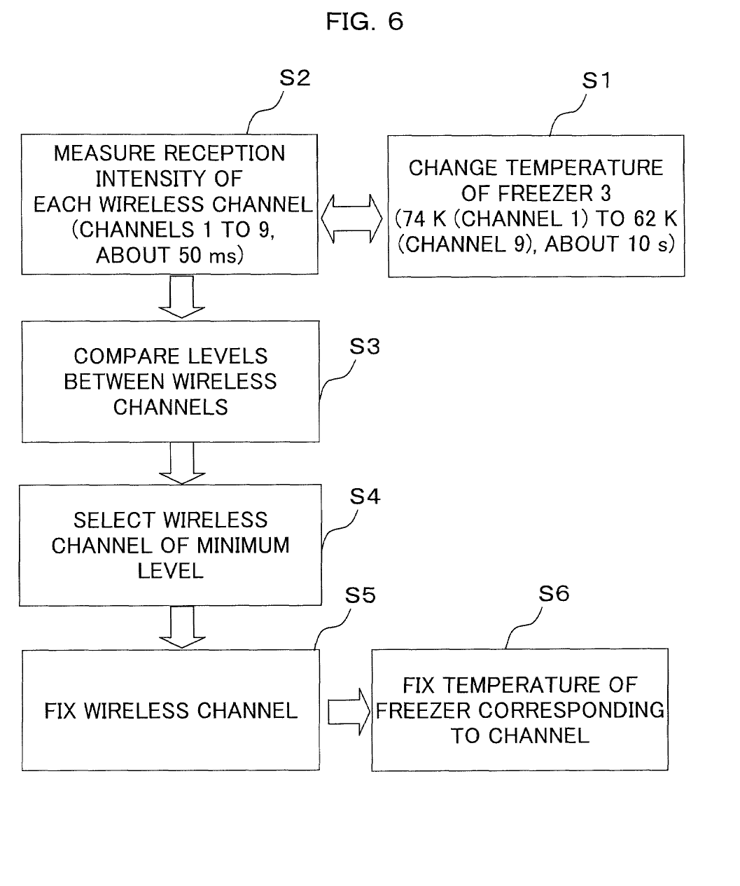

An exemplary operation of the reader/writer system 10 to which the above superconducting filter 12 is applied is explained with reference to FIG. 6. FIG. 6 is a flow chart illustrating a filter control operation of the reader/writer system 10.

First, the temperature controller 6 controls the temperature of the freezer 3 to change the temperature of the superconducting filter 12 from 74 (K) to 62 (K) (Step S1). The temperature control takes a time of about 10 (s). Hence, the center frequency f₀ of the superconducting filter 12 shifts in response to the change in temperature, and the signals of individual wireless channels are successively received.

Then, the reader/writer unit 4 measures the reception intensities of wireless signals of these wireless channels between 952.2 (MHz) (channel 1) and 953.8 (MHz) (channel 9) (Step S2). The measurement of the reception intensities of channels 1 to 9 takes a time of about 50 (ms). In other words, the process of measuring reception intensities at Step S2 is repeated during the temperature control (about 10 (s)) at Step S1.

Next, the reader/writer unit 4 compares the reception levels of the wireless channels (channels 1 to 9) with one another based on the measured reception intensities (Step S3). Specifically, the reception levels of the superconducting filter 12 from 952.2 (MHz) (channel 1) at a temperatures T of 74 to 953.8 (MHz) (channel 9) at a temperatures T of 62 are compared with one another.

The reader/writer unit 4 selects a wireless channel of the lowest level based on the comparison (Step S4), and determines (fixes) a wireless channel to be used between the wireless tags 11 and each reader/writer system (Step S5). This enables the unit 4 to detect the presence of the wireless channels used in the other reader/writer systems, and to select a wireless channel having the lowest reception intensity, so that a wireless channel which is not used by any other reader/writer system (or which suffers little interference from other reader/writer systems) is set for the concerned system 10, to be used for communication with the wireless tags 11.

Finally, the reader/writer unit 4 extracts the temperature information corresponding to the wireless channel that is determined at Step S5 from the ch-T database 5, and controls (fixes) the temperature of the freezer 3 based on the information (Step S6).

As described above, the reader/writer system 10 shifts the center frequency f₀ based on the temperature control of the superconducting filter 12 so that the superconducting filter 12 transmits signals of the wireless channel selected through the carrier sensing control by the reader/writer unit 4. Consequently, as described above, even when multiple reader/writer systems 10 are used close to one another, interference with any other reader/writer system can be prevented, and the communication performance between each reader/writer system 10 and the wireless tags 11 is not impaired.

### [B] Explanation of Variation

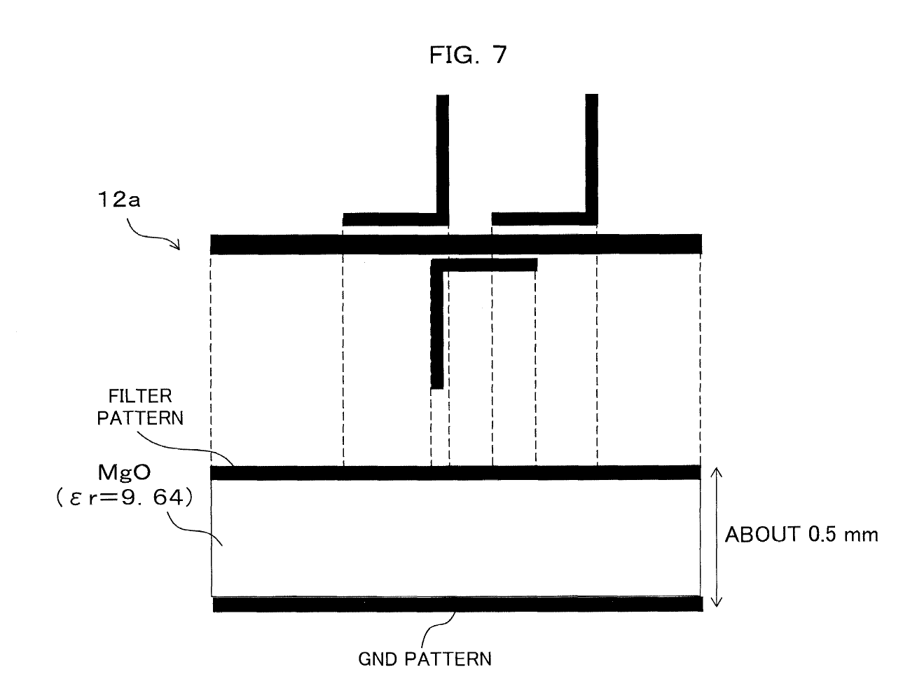

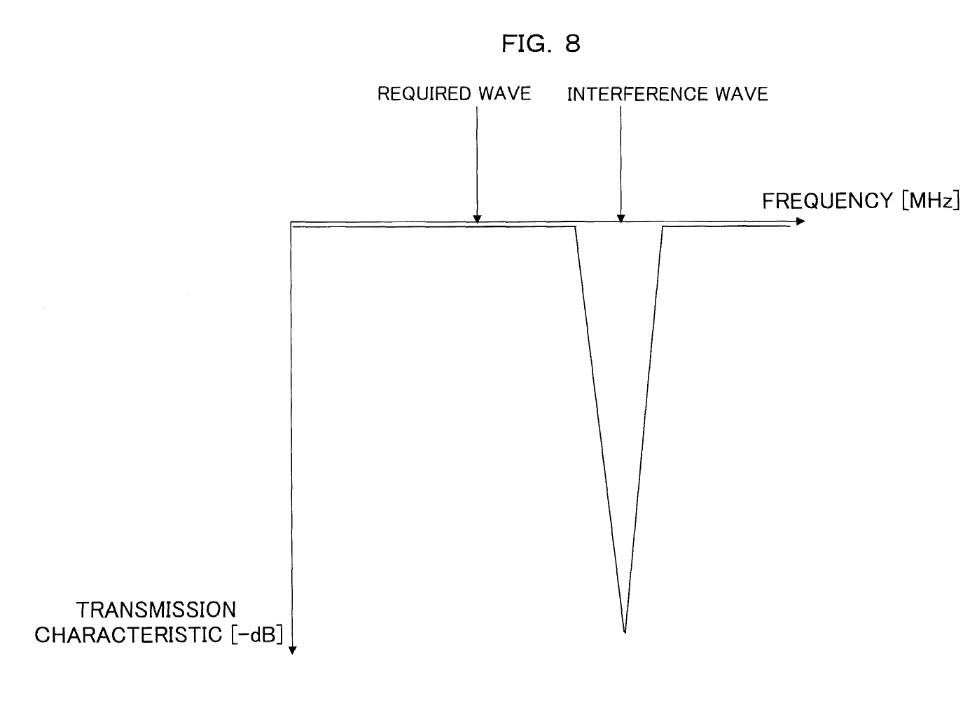

The embodiment described above encompasses the superconducting filter 12 being a bandpass filter. The filter 12 may be a bandstop (band rejection) filter, instead of the bandpass filter. In this variation, the bandstop filter is explained with reference to FIGS. 7 and 8.

FIG. 7 is a diagram illustrating a structure of a superconducting filter 12 which is a band rejection filter 12a. FIG. 8 is a graph illustrating the transmission loss of the superconducting filter 12a having the structure illustrated in FIG. 7.

As illustrated in FIG. 7, the superconducting filter 12a of this variation is also, for example, made of a magnesium oxide (MgO) substrate having a relative permittivity εᵣ of 9.64 and a thickness d of 0.5 mm, the substrate having one surface provided with a filter pattern composed of microstrip lines of yttrium-based oxide (YBCO) thereon, and the other surface with a ground (GND) pattern thereon. The formed filter pattern can reject a specific wireless band.

The superconducting filter 12a also has a center frequency, but rejects the wireless bands (rejection bands) around the center frequency, in contrast to the bandpass filter 12. The center frequency of the rejection band of the superconducting filter 12a also depends on the temperature as illustrated in FIGS. 3 and 4, similar to the center frequency of the pass band of the bandpass filter 12.

Consequently, as illustrated in FIG. 8, the reader/writer system having the superconducting filter 12a of this variation shifts the center frequency of the rejection bands of the superconducting filter 12a through the temperature control, to another frequency (interfering wireless channels) of signals (interference waves) from any other reader/writer system, which affects the signals of the reception frequency as interference components. This allows the wireless channel (required waves) selected through the carrier sensing control by the reader/writer unit to pass through, and the interference waves to be blocked, without fail.

Accordingly, the same advantages as those of the above embodiment are achieved. In addition, the superconducting filter being a band rejection filter rejects interfering wireless channels from the other reader/writer system without fail.

### [C] Others

Although the embodiment has been explained in detail, the embodiment is not limited to that embodiment, and may be modified without departing from the scope of the embodiment.

For example, the wireless channel is determined by the reader/writer unit 4 through a carrier sensing control in the embodiment and variation described above. Instead a wireless channel preliminarily determined or a wireless channel set by the wireless tags 11 may be used.

The superconducting filter (bandpass filter) 12 exhibits a smaller loss at a wider passband. When a wireless channel unused in the wireless frequencies in RFID (hereinafter referred to as an unused channel) is known in advance, preferably the super conducting filter 12 is set for a wider pass bandwidth which can include the unused channel. The pass bandwidths of the superconducting filter 12 depend on the distance between lines laid out in the filter pattern. For example, the narrower distance between lines laid out in the filter pattern provides the wider pass bandwidths to the superconducting filter 12, whereas the wider distance in the filter pattern provide the narrower pass bandwidth to the superconducting filter 12.

For example, in the reader/writer system 10 that uses only channels 1, 3, 5, 7 and 9 among wireless channels 1 to 9 in RFID, the distance between lines laid out in the filter pattern of the superconducting filter 12 is decreased to provide a pass bandwidth of 0.4 MHz for double channels, and the loss at the bandwidth is reduced to about a half. As a result, the transmission of the required wireless channel and the reduction in the loss at the pass band are achieved, and thereby the communication distances between the reader/writer system 10 and the wireless tags 11 can be extended, or the reception sensitivity can be improved.

In the reader/writer system 10 that uses only channels 1, 5 and 9 among wireless channels 1 to 9, the distance between lines laid out in the filter pattern of the superconducting filter 12 is adjusted to provide a pass bandwidth of 0.6 MHz for triple channels. Consequently, the pass bandwidth of the superconducting filter 12 may be set to be within a range from 0.2 MHz to 0.6 MHz to achieve a required communication distance or reception sensitivity.

Similarly, in the superconducting filter (band rejection filter) 12a, the distance between lines laid out in the filter pattern of the superconducting filter may be adjusted to provide one of the rejection bandwidths of 0.2 MHz for a single channel, 0.4 MHz for double channels, and 0.6 MHz for triple channels. This can further suppress interference of the wireless channels, which leads to the transmission of a required wireless channel and the reduction in the loss at the pass band. Therefore, the reduction in the communication distances between the reader/writer system and wireless tags can be more efficiently prevented.

In the above embodiment and variation, the reader/writer unit 4 measures reception intensities of signals of each wireless channel via the superconducting filter 12 (12a) during the carrier sensing control. Instead, a path from the reader/writer antenna 2 to the reader/writer unit 4, which bypasses the superconducting filter 12 (12a), may be further provided to measure the reception intensities of the signals of each wireless channel that are received via the path. The path can select (set) a wireless channel (reception frequency) of the minimum level based on the results of the reception intensity measurement before the temperature control by the superconducting filter 12 (12a), which leads to more rapid carrier sensing control.

According to the embodiments described above, at least one of the following effects or advantages can be obtained:

(1) Since the interference between wireless communication systems can be suppressed, a reduction in communication distance between a wireless communication system and a wireless tag can be prevented. In addition, the application of a filter to each wireless channel is not required, which prevents an increase in the size of the wireless communication system.

(2) When the temperature of a superconducting filter is controlled based on the relationship between each wireless frequency and the center frequency of the pass band or the rejection band of the superconducting filter, which is set in advance based on the changes in temperature of the pass band or the rejection band of the superconducting filter, the processing for the control can be simplified.

(3) When the controller of the wireless communication system measures the reception intensities of the signals received from other wireless communication systems, and selects the wireless frequency having the lowest reception intensity among the measured values as the reception frequency, the same advantage as (1) can be obtained under such a circumstance that multiple wireless communication systems are used close to one another.

(4) When the superconducting filter is used as a bandpass filter having a pass bandwidth that can transmit signals of adjacent wireless frequencies among the plurality of wireless frequencies, a reduction in the communication distance between a wireless communication system and a wireless tag can be more efficiently prevented, because the signal of the required wireless frequency can be received and the signal loss in the pass band can be reduced.

(5) When the superconducting filter is used as a band rejection filter having a rejection bandwidth that can reject signals of adjacent multiple wireless frequencies among the plurality of wireless frequencies, signals that may be interference components for the signal of the reception frequency can be rejected without fail, and the same advantage as (4) can be obtained, even if multiple signals that may be interference components are present.

As described above, according to the embodiments, interference between reader/writer systems can be suppressed, and the communication performance (communication distance and reception sensitivity) can be improved between reader/writer systems and wireless tags. Consequently, the embodiment is extremely useful in the field of wireless communication technology, specifically, of wireless communication technology using RFID.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment has been described in detail, it should be understood that the various changes, substitutions, and alterations could be made hereto without departing from the spirit and scope of the invention.

What is claimed is:

1. A method of controlling communication frequencies of a wireless communication system including a wireless tag, a superconducting filter that passes or blocks at least one of the signals of multiple wireless frequencies used for communication with the wireless tag, and a controller that controls the temperature of the superconducting filter, the method comprising:
on the controller,
selecting at least one of the multiple wireless frequencies as a reception frequency from the wireless tag; and
controlling the temperature of the superconducting filter in response to the selected frequency, whereby the pass band or rejection band of the superconducting filter is controlled.

2. The method of controlling communication frequencies of the wireless communication system according to claim 1, wherein
the superconducting filter is a bandpass filter, and
the controller shifts the center frequency of the pass band to the reception frequency through the temperature control.

3. The method of controlling communication frequencies of the wireless communication system according to claim 1, wherein
the superconducting filter is a band rejection filter, and
the controller shifts the center frequency of the rejection bands to frequencies of signals that affect the signals of the reception frequency as interference components through the temperature control.

4. The method of controlling communication frequencies of the wireless communication system according to claim 1, wherein
the controller controls the temperature based on the relationship between each of the wireless frequencies and the center frequency preset based on the change in temperature of the pass band or the rejection band of the superconducting filter.

5. The method of controlling communication frequencies of the wireless communication system according to claim 1, wherein
the controller measures the reception intensities of wireless signals received from the surrounding area of the controller, and
selects the wireless frequency having the lowest reception intensity among the measured values as the reception frequency.

6. A controller of the wireless communication system including a wireless tag; and a superconducting filter that passes or blocks at least one of the signals of multiple wireless frequencies used for communication with the wireless tag, the controller comprising:
reception frequency setting unit that sets at least one of the multiple wireless frequencies as a reception frequency from the wireless tag, and
temperature controlling unit that controls the temperature of the superconducting filter in response to the reception frequency selected by the reception frequency setting unit, whereby the pass band or rejection band of the superconducting filter is controlled.

7. The controller of the wireless communication system according to claim 6, wherein
the superconducting filter is a bandpass filter, and
the temperature controlling unit shifts the center frequency of the pass band to the reception frequency through the temperature control.

8. The controller of the wireless communication system according to claim 6, wherein
the superconducting filter is a band rejection filter, and
the temperature controlling unit shifts the center frequency of the rejection bands to a frequency of signals that affect the signals of the reception frequency, as interference components through the temperature control.

9. The controller of the wireless communication system according to claim 6, wherein
the controller further includes a memory that stores the relationship between each wireless frequency and the center frequency preset based on the change in temperature of the pass band or the rejection band of the superconducting filter, and
the temperature controlling unit controls the temperature based on the relationship stored in the memory.

10. The controller of the wireless communication system according to claim 6, wherein
the controller further comprises reception intensity measuring unit that measures reception intensities of wireless signals received from the surrounding area of the controller, and
the reception frequency setting unit sets a wireless frequency having the lowest reception intensity among the measured values by the reception intensity measuring unit as the reception frequency.

11. The controller of the wireless communication system according to claim 7, wherein the bandpass filter has a pass bandwidth capable of transmitting signals of adjacent wireless frequencies among the multiple wireless frequencies.

12. The controller of the wireless communication system according to claim 8, wherein the band rejection filter has a rejection bandwidth capable of rejecting signals of adjacent wireless frequencies among the multiple wireless frequencies.

13. A wireless communication system performing communication using a wireless tag and at least one of multiple wireless frequencies, the wireless communication system comprising:
a superconducting filter that passes or blocks at least one of the signals of the multiple wireless frequencies; and
a controller comprising reception frequency setting unit that sets at least one of the multiple wireless frequencies as a reception frequency from the wireless tag, and temperature controlling unit that controls the temperature of the superconducting filter in response to the reception frequency selected by the reception frequency setting unit, whereby the pass band or rejection band of the superconducting filter is controlled.
